(19) United States
(12) Patent Application Publication
(10) Pub. No.: US 2018/0267678 A1
(43) Pub. Date: Sep. 20, 2018

(54) TECHNIQUES AND ARCHITECTURES FOR MANAGING TEXT STRINGS TO BE PROVIDED BY A GRAPHICAL USER INTERFACE

(71) Applicant: salesforce.com, inc., San Francisco, CA (US)

(72) Inventors: Catherine Jane de Heer, Oakland, CA (US); Anthony Desportes, San Francisco, CA (US)

(73) Assignee: salesforce.com, inc., San Francisco, CA (US)

(21) Appl. No.: 15/458,584

(22) Filed: Mar. 14, 2017

(51) Int. Cl. G06F 3/0484

(52) U.S. Cl. CPC G06F 3/0484

(57) ABSTRACT

A system and related processing methodologies for managing text strings in a graphical user interface are disclosed here. The system is a computer-based system having a memory device and one or more processors configured to execute instructions stored on the memory device to perform a method that provides a user interface (UI) environment having a plurality of features, each of the plurality of features comprising at least one UI component. The method also creates associations between UI text strings, UI components, and features of the UI environment, generates different UI text string identifiers for each unique association of UI text string, UI component, and feature, and maintains, in the memory device, the created associations and the generated UI text string identifiers.

### TECHNICAL FIELD

Embodiments relate to techniques for managing content to be displayed on a graphical user interface. More particularly, embodiments relate to techniques for utilizing context to create and coordinate text string content to be displayed on the graphical user interface in conjunction with certain features and components.

### BACKGROUND

As part of the content they provide, graphical user interfaces generally include various text strings (i.e., user interface text or “UI text”) in connection with different features and functions. For example, various control and navigation elements such as buttons include UI text (e.g., “save,” “send,” and “cancel”). Other examples of graphical user interface elements that include UI text are links, labels for data fields, error messages, confirmation dialogs, legal notices such as disclaimers and agreements, inline help, walkthroughs, and alternative text (which is text read aloud by screen-reading software used by the blind). A complex software application or suite of applications may include hundreds or thousands (or more) of different text strings utilized with a variety of different features, functions, and/or contexts. Within such a complex system, it can be difficult, burdensome, and time consuming to write and maintain the text strings that appear in the software code that implements the system.

Accordingly, it is desirable to have a methodology that can be used to efficiently and effectively organize the UI text of a software application such as a graphical user interface. In addition, it is desirable to have a methodology that facilitates efficient and effective maintenance—that is, updating, correction, and revision—of UI text contained in a complex software application. Furthermore, other desirable features and characteristics will become apparent from the subsequent detailed description and the appended claims, taken in conjunction with the accompanying drawings and the foregoing technical field and background.

### BRIEF DESCRIPTION OF THE DRAWINGS

A more complete understanding of the subject matter may be derived by referring to the detailed description and claims in conjunction with the following figures, wherein like reference numbers refer to similar elements throughout the figures.

FIG. 1 is an exemplary representation of a user interface providing two windows in a single app;

FIG. 2 depicts some examples of UI text strings;

FIG. 3 illustrates a text string in the context of a feature;

FIG. 4 illustrates a text string in the context of a component;

FIG. 5 illustrates a text string in the context of a component and the feature in which it appears;

FIG. 6 is a block diagram representation of an exemplary environment in which an on-demand database service might be used; and

FIG. 7 is a block diagram representation of another exemplary environment in which an on-demand database service might be used.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

In the following description, numerous specific details are set forth. However, embodiments of the invention may be practiced without these specific details. In other instances, well-known structures and techniques have not been shown in detail in order to avoid obscuring the understanding of this description.

UI text strings are an essential part of the user interface (UI) of most software. Like any other text, such as the content of a book or a billboard, UI text works best if it is edited for qualities such as spelling, grammar, wording, consistency, and accuracy. That said, UI text strings typically are not organized in a way that allows them to be easily managed for those qualities. In accordance with the various embodiments described herein, however, improved systems and architectures can be utilized to overcome the problems caused by a lack of contextual information needed to efficiently write and maintain UI text strings in software. Various embodiments provide solutions by associating the UI text strings with context about the strings' appearance, behavior, purpose, and/or other characteristics in the software interface.

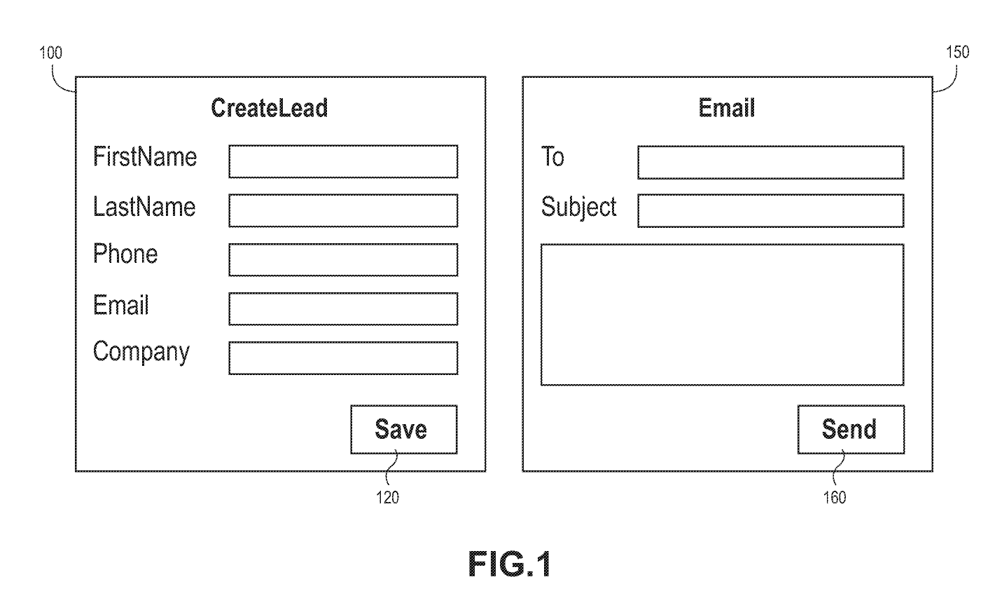

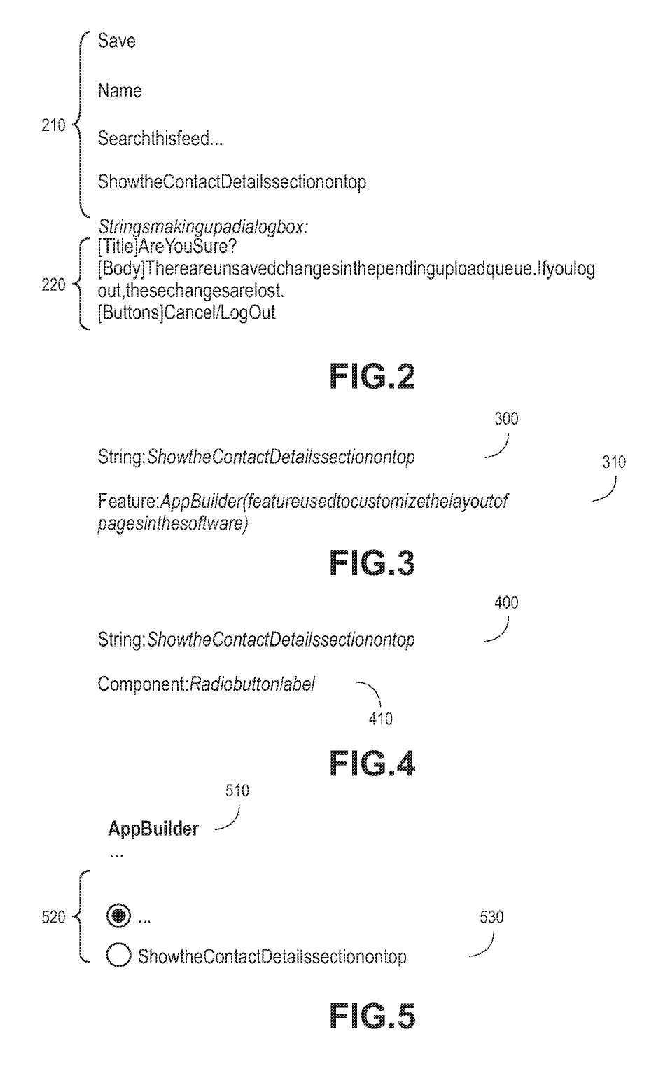

In this regard, FIG. 1 depicts two exemplary UI windows that may be generated by a single software application for display on a display device, and FIG. 2 depicts some examples of UI text strings. FIG. 1 depicts two exemplary UI windows 100, 150, which may be generated by the software application for concurrent display or for display at different times. Each window includes an active button element of the same overall design, but each button requires a different label (i.e., UI text rendered thereon). It should be appreciated that although FIG. 1 depicts only two windows 100, 150, any number of windows can be supported.

The Create Lead window 100 allows a sales rep to create a record for a new sales lead. She can accomplish this task by interacting with the window 100. When she has finished entering the lead's name and contact information, she saves the record by clicking the button 120, which is labeled “Save” in FIG. 1. For this example, the Create Lead window 100 represents one high level feature of the software application, the button 120 represents a UI component of the Create Lead feature, and the word “Save” represents the UI text string content that is associated with the button 120.

The Email window 150 allows the sales rep to write an email to the new lead. She can accomplish this by interacting with the window 150. When she has finished writing the email and is ready to send it, she clicks the Send button 160 in the lower right of the window 150. For this example, the Email window 150 represents a second high level feature of the software application, the button 160 represents a UI component of the Email feature, and the word “Send” represents the UI text string content that is associated with the button 160.

It should be appreciated that any number of UI text strings and other forms of UI content can be utilized by a software application. Indeed, the Create Lead window 100 also includes the following UI text strings: Create Lead; First Name; Last Name; Phone; Email; and Company. In addition, the Email window 150 also includes the following UI text strings: Email; To; and Subject. FIG. 2 provides some additional examples of UI text strings. The strings 210 are a few exemplary UI text strings (Save, Name, Search this feed, Show the Contact Details section on top) that can be used within a UI component. The strings 220 represent suitable UI text that may appear in a dialog box of a software application. These are merely several examples of UI text; in practice, a UI text string can be any word, a combination of words, letters, numbers, or characters, a single character, a phrase, or the like.

Complex software, for example the platforms and services provided by Salesforce.com, Inc., contains tens of thousands of UI text strings across various features. In this regard, a “feature” as used herein refers to a primary module or primary functionality of the software application, such as an email interface, a chat interface, a contacts module, a file uploader, a user profile page, or the like. A feature of an application may include, cooperate with, or be associated with any number of UI components, wherein a “component” represents a self-contained unit of software, for example, a reusable section of a UI. In this regard, a component can range in granularity from a single line of text to an assemblage of elements on a screen. Moreover, a component can include or encompass multiple sub-components if so desired. For example, in a Salesforce-based environment, a component carries information about appearance and behavior that determines the visual and interactive context of the associated UI text (e.g., how a user arrives at the screen, what she sees, and what can happen next). The feature in which the component is used determines the conceptual context of the associated UI text.

FIG. 3 illustrates a UI text string in the context of an application feature. In this example, the UI text string 300 is used in connection with an App Builder feature, which represents functionality used to customize the layout of pages within an app. Accordingly, the UI text string 300 has some relationship with corresponding feature information 310. Note that the feature information gives some context for the associated UI text string (e.g., what task a person uses the app to accomplish), but can leave out other contextual information (e.g., how the string helps the person accomplish the task). For example, the feature information may, indicate whether that particular instance of the UI text string appears as a heading, a link, next to a checkbox, etc. when presented to the user.

FIG. 4 illustrates a UI text string in the context of a UI component. In this example, the UI text string 400 is used in connection with a radio button element, which represents a UI component of the application. Accordingly, the UI text string 400 has some relationship with corresponding component information 410, which may indicate that the UI component associated with the UI text string 400 is a radio button, or that the UI text string 400 is to be used as a radio button label. Note that organizing text strings by UI components alone can provide a visual and interactive context, but may not provide a complete contextual description.

FIG. 5 illustrates a UI text string in the context of a UI component and the feature in which it appears. In this example, the UI text string 530 “Show the Contact Details section on top” is utilized with/by a radio button component 520 within an App Builder feature 510. Information related to this combination or the relationship between the UI text string 530, its corresponding component 520, and its corresponding feature 510 can be saved and maintained for purposes of managing the text strings of the host software application. With this amount of information, writers (or others) responsible for creating, editing, or changing UI text strings can efficiently and successfully determine suitable text. In other words, the association of a UI text string with a UI component and an application feature provides much or all of the context needed to ensure that the string accurately and usefully represents an action, instruction, or information in the UI, and to manage it within a repository.

In accordance with some existing software architectures, UI text is maintained in a suitably configured database, folder, or file in a way that allows the application code to reference the maintained UI text. However, the UI text is typically maintained with little to no additional contextual information. For example, in a context-free implementation, the UI text string “Submit” is maintained in a file with an identifier that can be used by the application code as a reference or pointer to that particular instantiation of the word “Submit.” In such an implementation, there can be multiple redundant entries for the same UI text string (“Submit”), which need not include the same identifier as the first instance, and which need not be used in the same context with the same application feature and/or with the same UI component. Consequently, a large and complex software application may include an unruly number of redundant, inconsistent, or duplicative UI text strings, which can make it very difficult to change, correct, or update UI text strings.

The problem of organizing UI text strings in traditional software architectures can manifest itself in several ways. For example, suppose that a single UI text string is used in disparate places associated with different functionality. A developer may want to change the string in one feature, but the change could adversely affect other features where the string is also referenced. Referring again to FIG. 1, suppose that the original design of the Create Lead window 100 used the word “Submit” as the label for the button 120, and that the original design of the Email window 150 also used the word “Submit” as the label for the button 160. Also assume that a developer decided to change the UI text string “Submit” to “Save.” That change makes good contextual sense for the Create Lead window 100 because clicking on the button 120 initiates an operation to save the new sales lead. Conversely, that change does not make good contextual sense for the Email window 150 because the functionality of the button 160 is to send the new email, not to save the email as a draft. Instead, the UI text for the button 160 should either be preserved (as “Submit”) or it should be changed to “Send” as it appears in FIG. 1, which makes better contextual sense for the Email feature. In contrast, if the button 160 were instead automatically updated to read “Save,” the sales rep would likely expect to preserve the authored email as a draft for sending in the future, not to immediately send it. Thus, referencing the wrong UI text string in a user interface can result in a serious flaw or bug. If the same UI text entry happens to be referenced by two or more different components (having different functionality), then changing that common UI text entry can produce unexpected results with respect to at least one of those components.

Therefore, determining which features a UI text string appears in, or which UI components reference it, can be a time-consuming and unreliable process. Even if a developer finds all the references in the code, the code may be structured in such a way that the desired change cannot be made without also making undesired changes to other strings. The methodology presented herein addresses this scenario by providing a reliable and efficient way to determine which components or features reference a UI text string. In other words, the methodology described herein enables the selective updating, changing, or revising of UI text strings in an efficient and effective manner, even if a UI text string to be changed appears in multiple different contexts within the UI environment.

Another potential issue with maintaining UI text in a context-free manner relates to the redundant use of strings. In this regard, suppose that multiple identical UI text strings are repeated many times in similar places across various features. For example, the label “Save” can be used many times in an app (e.g., as a button label). If a separate UI text string is created and centrally stored each time the word “Save” is used in a button, there could be a high level of redundancy within the environment, resulting in inefficiencies and unnecessary complexities. As another example, suppose that a developer wants to change the label “Cancel” to “Stop” throughout an app. The process of finding and changing all the desired UI text entries can be time consuming and produce unreliable results. After a developer has identified the different UI text entries in the appropriate database or folder, he then has to change each string separately. In some situations, there may be no way to change identical strings all at once across an app or a platform, so that each string has to be changed by a different developer. Changing even one string—including fixing an error such as a typo—can be a highly manual and expensive process involving multiple people (e.g., a writer, a product manager, a developer, and a quality engineer, and sometimes a localization program manager working with translators).

As another example of a potential issue with maintaining UI text in a context-free manner, suppose that multiple different UI text strings are used to convey the same message. For example, all of the following strings could be used to convey a similar meaning:

1) Error: You can't see this report because you can't view this record

2) You can't view this task because you don't have access to this account

3) Sorry, you can't view this record because you don't have permission

4) Error: You do not have access to this task

5) Error: Insufficient privileges

Manually searching a UI text database or repository for different but contextually similar UI text strings is not an effective way to find and correct this kind of inconsistency because the strings may not have enough in common.

For at least the reasons mentioned above, software developers everywhere face the problem of organizing UI text strings. Within a multi-tenant environment (e.g., the Salesforce environment), the problem affects performance, usability, customer support costs, localization, and productivity. These effects span features (e.g., Salesforce clouds) and disciplines across platforms (e.g., at Salesforce, user interfaces for desktop and mobile devices).

The issues and problems outlined above (for a system that maintains UI text in a context-free manner) are addressed by an exemplary methodology that provides sufficient information to write an accurate and useful UI text string, and sufficient information to organize and manage UI text strings in complex software. More specifically, the embodiments presented here create and maintain UI text with contextually relevant information, metadata, and/or indicators to cross-reference the UI text strings with key information about how they are actually used in the software application. In certain embodiments, each UI text entry in a repository, database, folder, or memory structure includes a UI text string that is associated with other pieces of information. In preferred embodiments, each string is saved in association with at least two additional contextually relevant pieces of information. Although not always required, the example described herein associates each UI text string with at least: (1) the UI component in which the UI text string appears; and (2) the application feature in which that UI component is used. Alternatively or additionally, a UI text string can be associated with one or more of the following, without limitation: the type of message to be conveyed by the UI text; a type, category, or classification of the associated application feature; and a type, category, or classification of the device to be used to provide the UI environment.

Merely knowing what feature a UI text string appears in (e.g., an account information feature, an email feature, a settings feature) need not, and usually will not, provide enough context to determine whether the wording of that particular UI text string is accurate or appropriate. In some systems or platforms, it is desirable for certain components to look and behave the same way across features. Nonetheless, merely knowing which component a UI text string appears in (e.g., a selectable button, an error message, or the like) need not, and usually will not, provide enough context to determine whether the wording of that UI text string is contextually correct. In practice, however, knowing the feature and the component associated with a UI text string is sufficient to provide the necessary context that accurately indicates what the UI text string looks like and how a user interacts with it.

In practice, the software developers create the desired associations between UI text strings, UI components, and features of the UI environment, and then save and maintain the corresponding data in an appropriate repository, database, or other structure defined in a memory device, storage element, or the like. Accordingly, the UI text repository for the software application includes a plurality of UI text entries, wherein each of the entries includes or defines the UI text string associations. In certain embodiments, each unique UI text entry includes a suitably formatted UI text string identifier that is also saved and maintained in connection with the respective UI text string association. The UI text string identifiers can serve as pointers or references in the software code of the UI environment, as mentioned previously. Thus, the string “Submit” might be found in two or more different and distinct UI text entries (due to different contextual uses of the word “Submit” throughout the application), but those different entries will be uniquely identified with distinguishable UI text string identifiers.

Conceptually, the association between a UI text string and other information such as its corresponding feature and its corresponding UI component can be referred to as cross-referencing because the additional data points can be used to provide a unique and more complete contextual picture. In the embodiments described herein, the data cross-referencing approach can serve as an organizing principle for a repository of UI text. Because each text string is uniquely identifiable by its context, a change to the content of any individual string affects only that string and no other. In this regard, UI text strings managed in the manner described herein can be handled more effectively than was previously possible. Moreover, UI text strings managed as described herein can be checked for quality more effectively than previously possible.

Uniquely identifying UI text strings by cross-referencing them with other information provides the context needed to write accurate and appropriate text for each string and to manage UI text effectively across software (e.g., at Salesforce, across the entire platform, across a partner app, or including acquired products and features). With UI text organized in this way, a writer or developer can change any UI text string in the application with confidence that he is not inadvertently changing other UI text strings.

As another benefit, UI text strings with unique identifiers can improve productivity and reduce the costs of updating and maintaining UI text across a platform. UI text strings with unique identifiers can be pulled into a repository (e.g., a content management system, or CMS). Writers responsible for the content of the strings can use a repository of UI text strings with unique identifiers to access and update strings without handling the code or involving developers, quality engineers, or product managers. A repository of UI text strings with unique identifiers can facilitate accurate and timely insertion and removal of strings, for example labels indicating release status such as beta or pilot. A repository of strings with unique identifiers also makes it much more feasible and cost effective for writers to attach code comments containing additional information for translators, making localization more efficient and accurate.

As another benefit, a repository of strings with unique identifiers can be used to improve quality, usability, and consistency. For example, a repository of UI text strings with unique identifiers can be accessed by a software component or module to check, confirm, or search for certain characteristics associated with the various strings. Such a repository makes it feasible and cost-effective to check all UI text for errors and ensure consistency (e.g., by running software for analyzing or optimizing content, such as the ACROLINX software product) and to quickly correct problems, for example before source content is delivered to translators, again without involving developers, quality engineers, or product managers. In turn, such a repository makes localization more efficient and effective by improving the source content that translators work from. These improvements can be made to source content in any language. As another example, a repository of UI text strings with unique identifiers can be used to identify all content in similar components and repeat desirable patterns of voice and tone. For example, if an error occurs after a user edits data, software can display a variety of messages, and when messages with similar meanings are worded in different ways in each feature, software is harder to use. A repository of UI text strings with unique identifiers makes it feasible and cost-effective to identify messages with similar meanings and update messages for consistency.

As another benefit, a repository of UI text strings with unique identifiers can be used to improve performance by facilitating the identification of redundant strings with identical wording (e.g., “Save”), which can then be replaced with references to a single label. Such changes can also optimize performance by minimizing the number of UI text strings. Such changes can also reduce localization costs by improving the source content that translators work from and reducing the number of different phrases to be translated.

As another benefit, a repository of UI text strings with unique identifiers can also be used to facilitate the integration of products and features added through the acquisition of companies, for example when those products and features are built using similar components.

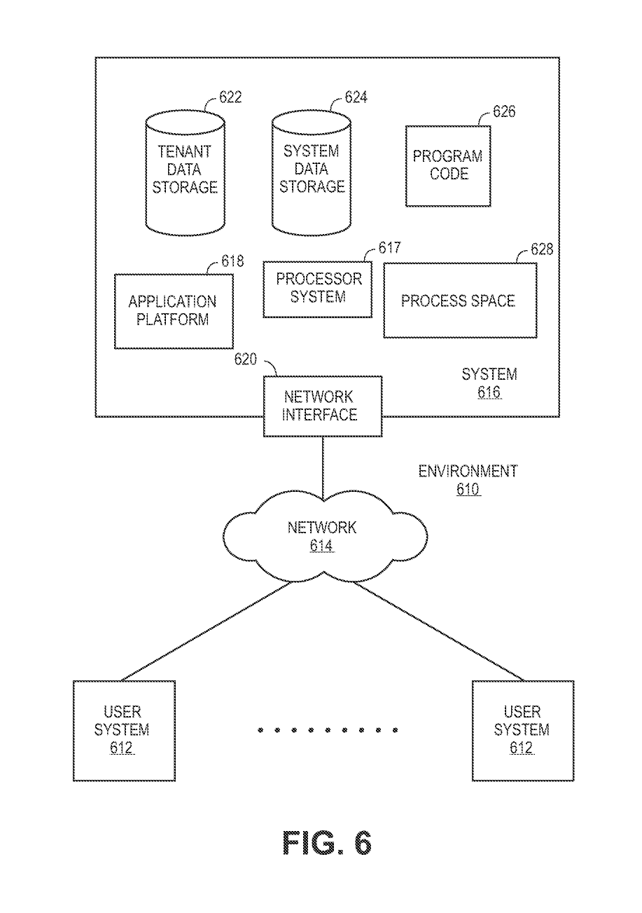

The approaches and methodologies presented here can be utilized in various computer-based environments, network environments, and/or database system environments. In this regard, FIG. 6 illustrates a block diagram of an environment 610 wherein an on-demand database service might be used for purposes of supporting the subject matter described in more detail above. Environment 610 may include user systems 612, network 614, system 616, processor system 617, application platform 618, network interface 620, tenant data storage 622, system data storage 624, program code 626, and process space 628. In other embodiments, environment 610 may not have all of the components listed and/or may have other elements instead of, or in addition to, those listed above.

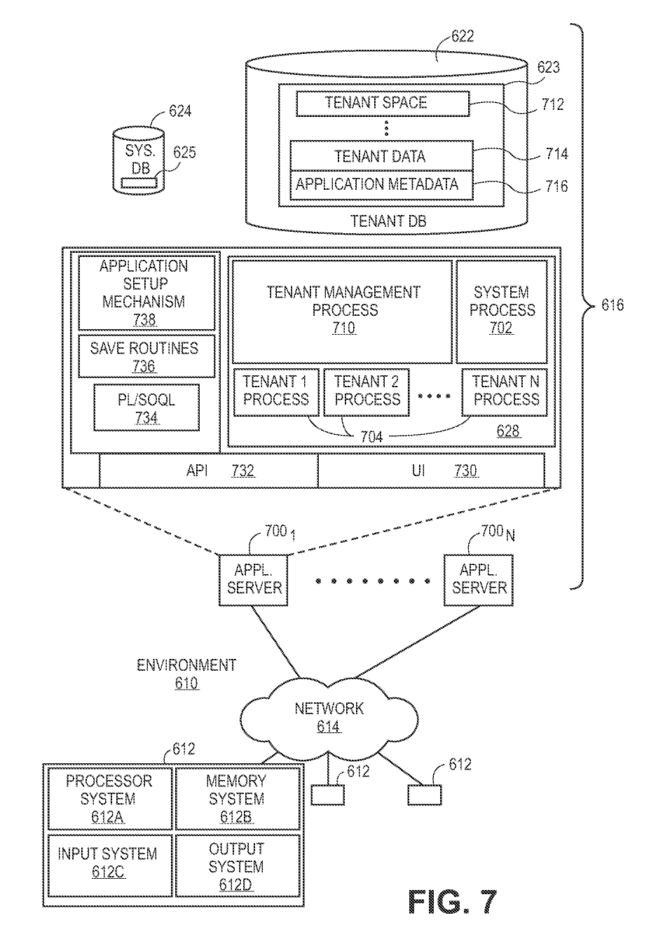

Environment 610 is an environment in which an on-demand database service exists. User system 612 may be any machine or system that is used by a user to access a database user system. For example, any of user systems 612 can be a handheld computing device, a mobile phone, a laptop computer, a work station, and/or a network of computing devices. As illustrated in herein FIG. 6 (and in more detail in FIG. 7) user systems 612 might interact via a network 614 with an on-demand database service, which is system 616.

An on-demand database service, such as system 616, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 616” and “system 616” will be used interchangeably herein. A database image may include one or more database objects. A relational database management system (RDMS) or the equivalent may execute storage and retrieval of information against the database object(s). Application platform 618 may be a framework that allows the applications of system 616 to run, such as the hardware and/or software, e.g., the operating system. In an embodiment, on-demand database service 616 may include an application platform 618 that enables creation, managing and executing one or more applications developed by the provider of the on-demand database service, users accessing the on-demand database service via user systems 612, or third party application developers accessing the on-demand database service via user systems 612.

The users of user systems 612 may differ in their respective capacities, and the capacity of a particular user system 612 might be entirely determined by permissions (permission levels) for the current user. For example, where a salesperson is using a particular user system 612 to interact with system 616, that user system has the capacities allotted to that salesperson. However, while an administrator is using that user system to interact with system 616, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 614 is any network or combination of networks of devices that communicate with one another. For example, network 614 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the Internet, that network will be used in many of the examples herein. However, it should be understood that the networks that one or more implementations might use are not so limited, although TCP/IP is a frequently implemented protocol.

User systems 612 might communicate with system 616 using TCP/IP and, at a higher network level, use other common Internet protocols to communicate, such as HTTP, FTP, AFS, WAP, etc. In an example where HTTP is used, user system 612 might include an HTTP client commonly referred to as a “browser” for sending and receiving HTTP messages to and from an HTTP server at system 616. Such an HTTP server might be implemented as the sole network interface between system 616 and network 614, but other techniques might be used as well or instead. In some implementations, the interface between system 616 and network 614 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 616, shown in FIG. 6, implements a web-based customer relationship management (CRM) system. For example, in one embodiment, system 616 includes application servers configured to implement and execute CRM software applications as well as provide related data, code, forms, webpages and other information to and from user systems 612 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 616 implements applications other than, or in addition to, a CRM application. For example, system 616 may provide tenant access to multiple hosted (standard and custom) applications, including a CRM application. User (or third party developer) applications, which may or may not include CRM, may be supported by the application platform 618, which manages creation, storage of the applications into one or more database objects and executing of the applications in a virtual machine in the process space of the system 616.

One arrangement for elements of system 616 is shown in FIG. 6, including a network interface 620, application platform 618, tenant data storage 622 for tenant data 623, system data storage 624 for system data 625 accessible to system 616 and possibly multiple tenants, program code 626 for implementing various functions of system 616, and a process space 628 for executing MTS system processes and tenant-specific processes, such as running applications as part of an application hosting service. Additional processes that may execute on system 616 include database indexing processes.

Several elements in the system shown in FIG. 6 include conventional, well-known elements that are explained only briefly here. For example, each user system 612 could include a desktop personal computer, workstation, laptop, PDA, cell phone, or any wireless access protocol (WAP) enabled device or any other computing device capable of interfacing directly or indirectly to the Internet or other network connection. User system 612 typically runs an HTTP client, e.g., a browsing program, such as Edge from Microsoft, Safari from Apple, Chrome from Google, or a WAP-enabled browser in the case of a cell phone, PDA or other wireless device, or the like, allowing a user (e.g., subscriber of the multi-tenant database system) of user system 612 to access, process and view information, pages and applications available to it from system 616 over network 614. Each user system 612 also typically includes one or more user interface devices, such as a keyboard, a mouse, touch pad, touch screen, pen or the like, for interacting with a graphical user interface (GUI) provided by the browser on a display (e.g., a monitor screen, LCD display, etc.) in conjunction with pages, forms, applications and other information provided by system 616 or other systems or servers. For example, the user interface device can be used to access data and applications hosted by system 616, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 612 and all of its components are operator configurable using applications, such as a browser, including computer code run using a central processing unit such as an Intel Core series processor or the like. Similarly, system 616 (and additional instances of an MTS, where more than one is present) and all of their components might be operator configurable using application(s) including computer code to run using a central processing unit such as processor system 617, which may include an Intel Core series processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 616 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 616 is configured to provide webpages, forms, applications, data and media content to user (client) systems 612 to support the access by user systems 612 as tenants of system 616. As such, system 616 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 7 also illustrates environment 610. However, in FIG. 7 elements of system 616 and various interconnections in an embodiment are further illustrated. FIG. 7 shows that user system 612 may include processor system 612A, memory system 612B, input system 612C, and output system 612D. FIG. 7 shows network 614 and system 616. FIG. 7 also shows that system 616 may include tenant data storage 622, tenant data 623, system data storage 624, system data 625, User Interface (UI) 730, Application Program Interface (API) 732, PL/SOQL 734, save routines 736, application setup mechanism 738, applications servers 7001-700N, system process space 702, tenant process spaces 704, tenant management process space 710, tenant storage area 712, user storage 714, and application metadata 716. In other embodiments, environment 610 may not have the same elements as those listed above and/or may have other elements instead of, or in addition to, those listed above.

User system 612, network 614, system 616, tenant data storage 622, and system data storage 624 were discussed above in FIG. 6. Regarding user system 612, processor system 612A may be any combination of one or more processors. Memory system 612B may be any combination of one or more memory devices, short term, and/or long term memory. Input system 612C may be any combination of input devices, such as one or more keyboards, mice, trackballs, scanners, cameras, and/or interfaces to networks. Output system 612D may be any combination of output devices, such as one or more monitors, printers, and/or interfaces to networks. As shown by FIG. 7, system 616 may include a network interface 620 (of FIG. 6) implemented as a set of HTTP application servers 700, an application platform 618, tenant data storage 622, and system data storage 624. Also shown is system process space 702, including individual tenant process spaces 704 and a tenant management process space 710. Each application server 700 may be configured to tenant data storage 622 and the tenant data 623 therein, and system data storage 624 and the system data 625 therein to serve requests of user systems 612. The tenant data 623 might be divided into individual tenant storage areas 712, which can be either a physical arrangement and/or a logical arrangement of data. Within each tenant storage area 712, user storage 714 and application metadata 716 might be similarly allocated for each user. For example, a copy of a user's most recently used (MRU) items might be stored to user storage 714. Similarly, a copy of MRU items for an entire organization that is a tenant might be stored to tenant storage area 712. A UI 730 provides a user interface and an API 732 provides an application programmer interface to system 616 resident processes to users and/or developers at user systems 612. The tenant data and the system data may be stored in various databases, such as one or more Oracle™ databases.

Application platform 618 includes an application setup mechanism 738 that supports application developers' creation and management of applications, which may be saved as metadata into tenant data storage 622 by save routines 736 for execution by subscribers as one or more tenant process spaces 704 managed by tenant management process 710 for example. Invocations to such applications may be coded using PL/SOQL 734 that provides a programming language style interface extension to API 732. Invocations to applications may be detected by one or more system processes, which manage retrieving application metadata 716 for the subscriber making the invocation and executing the metadata as an application in a virtual machine.

Each application server 700 may be communicably coupled to database systems, e.g., having access to system data 625 and tenant data 623, via a different network connection. For example, one application server 7001 might be coupled via the network 614 (e.g., the Internet), another application server 700N-1 might be coupled via a direct network link, and another application server 700N might be coupled by yet a different network connection. Transfer Control Protocol and Internet Protocol (TCP/IP) are typical protocols for communicating between application servers 700 and the database system. However, it will be apparent to one skilled in the art that other transport protocols may be used to optimize the system depending on the network interconnect used.

In certain embodiments, each application server 700 is configured to handle requests for any user associated with any organization that is a tenant. Because it is desirable to be able to add and remove application servers from the server pool at any time for any reason, there is preferably no server affinity for a user and/or organization to a specific application server 700. In one embodiment, therefore, an interface system implementing a load balancing function (e.g., an F5 BIG-IP load balancer) is communicably coupled between the application servers 700 and the user systems 612 to distribute requests to the application servers 700. In one embodiment, the load balancer uses a least connections algorithm to route user requests to the application servers 700. Other examples of load balancing algorithms, such as round robin and observed response time, also can be used. For example, in certain embodiments, three consecutive requests from the same user could hit three different application servers 700, and three requests from different users could hit the same application server 700. In this manner, system 616 is multi-tenant, wherein system 616 handles storage of, and access to, different objects, data and applications across disparate users and organizations.

As an example of storage, one tenant might be a company that employs a sales force where each salesperson uses system 616 to manage their sales process. Thus, a user might maintain contact data, leads data, customer follow-up data, performance data, goals and progress data, etc., all applicable to that user's personal sales process (e.g., in tenant data storage 622). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 616 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 616 might also maintain system level data usable by multiple tenants or other data. Such system level data might include industry reports, news, postings, and the like that are sharable among tenants.

In certain embodiments, user systems 612 (which may be client systems) communicate with application servers 700 to request and update system-level and tenant-level data from system 616 that may require sending one or more queries to tenant data storage 622 and/or system data storage 624. System 616 (e.g., an application server 700 in system 616) automatically generates one or more SQL statements (e.g., one or more SQL queries) that are designed to access the desired information. System data storage 624 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table.”

In some multi-tenant database systems, tenants may be allowed to create and store custom objects, or they may be allowed to customize standard entities or objects, for example by creating custom fields for standard objects, including custom index fields. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. In certain embodiments, the program or code segments are stored in a tangible processor-readable medium, which may include any medium that can store or transfer information. Examples of a non-transitory and processor-readable medium include an electronic circuit, a semiconductor memory device, a ROM, a flash memory, an erasable ROM (EROM), a floppy diskette, a CD-ROM, an optical disk, a hard disk, or the like.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A non-transitory computer-readable medium having stored thereon instructions that, when executed by one or more processors, are configurable to cause the one or more processors to:
provide a user interface (UI) environment comprising a plurality of features, each of the plurality of features comprising at least one UI component;
create associations between UI text strings, UI components, and features of the UI environment;
generate different UI text string identifiers for each unique association of UI text string, UI component, and feature; and
maintain, in a memory device, the created associations and the generated UI text string identifiers.

2. The non-transitory computer-readable medium of claim 1, wherein at least some of the UI components are used in multiple contexts within the UI environment, and with identical UI text strings for each of the multiple contexts.

3. The non-transitory computer-readable medium of claim 1, wherein the UI text strings comprise labels for the UI components.

4. The non-transitory computer-readable medium of claim 1, wherein the UI text strings are stored in a database and organized according to the UI components with which the respective UI text strings are used.

5. The non-transitory computer-readable medium of claim 1, wherein the UI text strings are stored in a repository that is accessible for purposes of checking characteristics of the UI text strings.

6. The non-transitory computer-readable medium of claim 1, wherein, for at least some of the UI text strings, the instructions are configurable to cause the one or more processors to create further associations between the UI text strings and additional contextually relevant information to supplement the associations between the UI text strings, UI components, and features of the UI environment.

7. A method comprising:
providing a user interface (UI) environment comprising a plurality of features, each of the plurality of features comprising at least one UI component;
creating associations between UI text strings, UI components, and features of the UI environment;
generating different UI text string identifiers for each unique association of UI text string, UI component, and feature; and
maintaining, in a memory device, the created associations and the generated UI text string identifiers.

8. The method of claim 7, wherein at least some of the UI components are used in multiple contexts within the UI environment, and with identical UI text strings for each of the multiple contexts.

9. The method of claim 7, wherein the UI text strings comprise labels for the UI components.

10. The method of claim 7, wherein the UI text strings are stored in a database and organized according to the UI components with which the respective UI text strings are used.

11. The method of claim 7, wherein the UI text strings are stored in a repository that is accessible for purposes of checking characteristics of the UI text strings.

12. The method of claim 7, wherein, for at least some of the UI text strings, the creating step creates further associations between the UI text strings and additional contextually relevant information to supplement the associations between the UI text strings, UI components, and features of the UI environment.

13. The method of claim 7, wherein the generated UI text string identifiers are referenced in program code of the UI environment.

14. A system comprising:
a memory device; and
one or more processors coupled with the memory device, the one or more processors configurable to:
provide a user interface (UI) environment comprising a plurality of features, each of the plurality of features comprising at least one UI component;
create associations between UI text strings, UI components, and features of the UI environment;
generate different UI text string identifiers for each unique association of UI text string, UI component, and feature; and
maintain, in the memory device, the created associations and the generated UI text string identifiers.

15. The system of claim 14, wherein at least some of the UI components are used in multiple contexts within the UI environment, and with identical UI text strings for each of the multiple contexts.

16. The system of claim 14, wherein the UI text strings comprise labels for the UI components.

17. The system of claim 14, wherein the UI text strings are stored in a database and organized according to the UI components with which the respective UI text strings are used.

18. The system of claim 14, wherein the UI text strings are stored in a repository that is accessible for purposes of checking characteristics of the UI text strings.

19. The system of claim 14, wherein, for at least some of the UI text strings, the one or more processors are configurable to create further associations between the UI text strings and additional contextually relevant information to supplement the associations between the UI text strings, UI components, and features of the UI environment.

20. The system of claim 14, wherein the generated UI text string identifiers are referenced in program code of the UI environment.
